(19) United States
(12) Patent Application Publication
(10) Pub. No.: US 2026/0350842 A1
(43) Pub. Date: Nov. 5, 2026

(54) SYSTEMS AND METHODS OF COLOR CORRECTION FOR COLORIMETRIC MEASUREMENTS

(71) Applicant: Ohio State Innovation Foundation, Columbus, OH (US)

(72) Inventors: Karen DANNEMILLER, Columbus, OH (US); Rongjun QIN, Columbus, OH (US); Jenny PANESCU, Columbus, OH (US); Guixiang ZHANG, Columbus, OH (US); Shuang SONG, Columbus, OH (US)

(21) Appl. No.: 19/118,906

(22) PCT Filed: Oct. 6, 2023
(86) PCT No.: PCT/US2023/034675

§ 371 Date: Apr. 7, 2025

Related U.S. Application Data
(60) Provisional application No. 63/378,540, filed on Oct. 6, 2022.

(51) Int. Cl. G06T 7/90; G06T 7/80; H04N 9/64; H04N 23/60

(52) U.S. Cl. CPC G06T 7/90; G06T 7/80; H04N 9/64; H04N 23/64; G06T 2207/10024; G06T 2207/30204; G06T 2207/30244

(57) ABSTRACT

Systems and methods of color correction for colorimetric measurements are described herein. An example method includes receiving an image of a color reference board, the color reference board including a sample region, a calibration region, and a plurality of coded markers. The method includes obtaining, using the image, a plurality of respective color values associated with the at least one color stripe and the object of interest; determining a first model based on respective coordinates associated with the coded markers; transforming, using the first model, the respective color values and a coordinate grid associated with the object of interest into a plurality of respective adjusted color values and an adjusted coordinate grid associated with the object of interest; and correcting, using a second model, the respective adjusted color values associated with the object of interest to obtain a plurality of respective corrected color values associated with the object of interest.

### CROSS-REFERENCE TO RELATED APPLICATIONS

This application claims the benefit of U.S. provisional patent application No. 63/378,540 filed on Oct. 6, 2022, and titled “SYSTEMS AND METHODS OF COLOR CORRECTION FOR COLORIMETRIC MEASUREMENTS,” the contents of which are expressly incorporated herein by reference in their entirety.

### BACKGROUND

Quantifying the colors of objects is useful in a wide range of applications, including medical diagnosis, agricultural monitoring, and food safety. Accurate colorimetric measurement of objects is a laborious process normally performed through a color matching test in the laboratory. A promising alternative is to use digital images for colorimetric measurement, due to its portability and ease of use. However, the image-based measurements suffer from errors caused by the non-linear nature of the image formation processes and unpredictable environmental lighting. Solutions to this problem often perform relative color correction among multiple images through discrete color reference boards, which may yield biased correction results due to the lack of continuous observation.

### SUMMARY

Systems and methods of color correction for colorimetric measurements are described herein. An example method includes receiving an image of a color reference board, where the color reference board includes a sample region, a calibration region, and a plurality of coded markers. The sample region is configured to receive an object of interest, and the calibration region includes at least one color stripe. The method also includes obtaining, using the image, a plurality of respective color values associated with the at least one color stripe and the object of interest; and determining a first model based on respective coordinates associated with the coded markers. Additionally, the method includes transforming, using the first model, the respective color values and a coordinate grid associated with the object of interest into a plurality of respective adjusted color values and an adjusted coordinate grid associated with the object of interest. The method further includes correcting, using a second model, the respective adjusted color values associated with the object of interest to obtain a plurality of respective corrected color values associated with the object of interest.

In some implementations, the computer-implemented method, further includes: performing, using the respective corrected color values associated with the object of interest, a colorimetric measurement.

In some implementations, the first model is an imaging device coordinate system transformation model.

In some implementations, the second model is a spatial varying coefficient model (SVCM).

In some implementations, the second model is a 1st or 2nd order SVCM.

In some implementations, the sample region is arranged centrally with respect to the calibration region.

In some implementations, respective color values associated with the at least one color stripe represent a sampling of a color space.

In some implementations, the color space is defined as a hue, saturation, and value (HSV) space.

In some implementations, the coded markers include an ArUco marker.

In some implementations, the at least one color stripe extends between a pair of the coded markers.

In some implementations, the computer-implemented method further includes: determining, using the coded markers, an optimal image-capture pose relative the color reference board in a three-dimensional (3D) space.

In some implementations, the optimal image-capture pose is determined by minimizing an effect of reflectance on image capture.

In some implementations, the optimal image-capture pose is approximately parallel to the color reference board.

In some implementations, the computer-implemented method further includes: providing an image capture instruction to a user in response to determining the optimal image-capture pose.

In some implementations, the computer-implemented method further includes: providing a coded marker tracking instruction to a user.

In some implementations, the object of interest is a test strip.

In some implementations, a computing device is provided. The computing device can include: a processor; and a memory operably coupled to the processor, wherein the memory has computer-executable instructions stored thereon that, when executed by the processor, cause the processor to: receive an image of a color reference board, wherein the color reference board includes a sample region, a calibration region, and a plurality of coded markers, the sample region including an object of interest, and the calibration region including at least one color stripe; obtain, using the image, a plurality of respective color values associated with the at least one color stripe and the object of interest; determine a first model based on respective coordinates associated with the coded markers; transform, using the first model, the respective color values and a coordinate grid associated with the object of interest into a plurality of respective adjusted color values and an adjusted coordinate grid associated with the object of interest; and correct, using a second model, the respective adjusted color values associated with the object of interest to obtain a plurality of respective corrected color values associated with the object of interest.

In some implementations, the computing device further includes or is operatively coupled to an imaging device configured to capture the image of the color reference board.

In some implementations, the computer-executable instructions further include instructions that, when executed by the processor, cause the processor to further: perform, using the respective corrected color values associated with the object of interest, a colorimetric measurement.

In some implementations, the first model is an imaging device coordinate system transformation model.

In some implementations, the second model is a spatial varying coefficient model (SVCM).

In some implementations, the second model is a 1st or 2nd order SVCM.

In some implementations, the sample region is arranged centrally with respect to the calibration region.

In some implementations, respective color values associated with the at least one color stripe represent a sampling of a color space.

In some implementations, the color space is defined as a hue, saturation, and value (HSV) space.

In some implementations, the coded markers include an ArUco marker.

In some implementations, the techniques the at least one color stripe extends between a pair of the coded markers.

In some implementations, the computer-executable instructions further include instructions that, when executed by the processor, cause the processor to further: determine, using the coded markers, an optimal image-capture pose relative the color reference board in a three-dimensional (3D) space.

In some implementations, the optimal image-capture pose is determined by minimizing an effect of reflectance on image capture.

In some implementations, the optimal image-capture pose is approximately parallel to the color reference board.

In some implementations, the computer-executable instructions further include instructions that, when executed by the processor, cause the processor to further: provide an image capture instruction to a user in response to determining the optimal image-capture pose.

In some implementations, the computer-executable instructions further include instructions that, when executed by the processor, cause the processor to further: provide a coded marker tracking instruction to a user.

In some implementations, the object of interest is a test strip.

In some implementations, the techniques described herein relate to a system including: a color reference board, wherein the color reference board includes a sample region, a calibration region, and a plurality of coded markers, the sample region being configured to receive an object of interest, and the calibration region including at least one color stripe; and a portable computing device including a processor, a memory operably coupled to the processor, and an imaging device, wherein the memory has computer-executable instructions stored thereon that, when executed by the processor, cause the processor to: receive an image of the color reference board captured by the imaging device; obtain, using the image, a plurality of respective color values associated with the at least one color stripe and the object of interest; determine a first model based on respective coordinates associated with the coded markers; transform, using the first model, the respective color values and a coordinate grid associated with the object of interest into a plurality of respective adjusted color values and an adjusted coordinate grid associated with the object of interest; and correct, using a second model, the respective adjusted color values associated with the object of interest to obtain a plurality of respective corrected color values associated with the object of interest.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A shows an example pH test kit.

FIG. 1B shows examples of properties that a color-changing test kit can be used to detect.

FIG. 1C is a diagram illustrating example color correction methods for colorimetric measurements according to implementations described herein. In particular, FIG. 1C illustrates an example color reference board that can combine with other test kits or derive new kits. Additionally, FIG. 1C illustrates augmented reality (AR)-based image capture to continuously provide movement guidance to users leading to an optimal position for best capturing quality. FIG. 1C also illustrates a color correction algorithm that aligns images taken under natural illumination to the standard color reference board which leads to other post-processes (e.g., automatic reading).

FIG. 2A, FIG. 2B, FIG. 2C and FIG. 2D illustrate a color reference board and the visualization of sample point in hue, saturation, value (HSV) color space. Specifically, FIG. 2A depicts a source file of an example color reference board, FIG. 2B shows source color samples in HSV space, FIG. 2C shows a digitalized file of color reference board, and FIG. 2D shows digitalized color samples in HSV space.

FIG. 3 is a computing device.

FIG. 4 is a workflow of an example augmented reality-based image capture module in accordance with certain embodiments of the present disclosure.

FIG. 5 is a schematic illustration showing definitions of coordinate frames in a system in accordance with certain embodiments of the present disclosure.

FIG. 6A, FIG. 6B, and FIG. 6C provide an operational example of using the augmented reality-based visual guidance module.

FIG. 7A and FIG. 7B show examples of parametric 2d-spatial varying functions.

FIG. 8A, FIG. 8B, and FIG. 8C present an operational example of applying a color correction algorithm.

FIG. 9 depicts a rendered color mosaic and designs of various color reference boards.

FIG. 10 shows the performance of different combinations of color stripe patterns and models.

FIG. 11 is a graph depicting the curve of mean root mean squared error (mRMSE) vs viewing angles.

FIG. 12A and FIG. 12C show images taken under two different mixed lights by iPhone SE 2nd generation and iphone XSMAX, respectively; and FIG. 12B and FIG. 12D are the corresponding images after color correction.

FIG. 13 is a graph showing color correction performance of different binder clips.

FIG. 14 shows an example cropped and rectified image of a reference card and test paper.

FIG. 15 illustrates a pH value interpolation method.

FIG. 16A is a table showing a comparison of different colorimetric measurement methods.

FIG. 16B is a table showing pH errors and values measured by human observers and smartphone apps with and without the proposed correction algorithm under different lighting conditions.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. As used herein, the terms “about” or “approximately” when referring to a measurable value such as an amount, a percentage, and the like, is meant to encompass variations of +20%, +10%, +5%, or +1% from the measurable value.

Quantifying the colors of objects is useful in a wide range of applications, including medical diagnosis, agricultural monitoring, and food safety. Accurate colorimetric measurement of objects is a laborious process normally performed through a color matching test in the laboratory. A promising alternative is to use digital images for colorimetric measurement, due to their portability and ease of use. However, image-based measurements suffer from errors caused by the non-linear image formation process and unpredictable environmental lighting. Solutions to this problem often perform relative color correction among multiple images through discrete color reference boards, which may yield biased results due to the lack of continuous observation. Embodiments of the present disclosure provide a smartphone-based solution, that couples a designated color reference board with a novel color correction algorithm, to achieve accurate and absolute color measurements. The color reference board contains multiple color stripes with continuous color sampling at the sides. A novel correction algorithm is proposed to utilize a first-order spatial varying regression model to perform the color correction, which leverages both the absolute color magnitude and scale to maximize the correction accuracy. The proposed algorithm can be implemented as a “human-in-the-loop” smartphone application, where users are guided by an augmented reality scheme with a marker tracking module to take images at an angle that minimizes the impact of non-Lambertian reflectance. The experimental results show that the colorimetric measurement is device independent and can reduce up to 90% color variance for images collected under different lighting conditions. In the application of reading pH values from test papers, it was shown that the proposed system performs 200% better than human reading. The designed color reference board, the correction algorithm, and the augmented reality guiding approach form an integrated system as a novel solution to measure color with increased accuracy. This technique has the flexibility to improve color reading performance in systems beyond existing applications, evidenced by both qualitative and quantitative experiments on example applications such as pH-test reading.

Systems and methods of color correction for colorimetric measurements are described herein. As discussed above, image-based colorimetric measurements suffer from errors caused by the non-linear nature of the image formation processes and unpredictable environmental lighting. The systems and methods described herein, which include a color reference board, a color correction algorithm, and augmented reality (AR)-based guidance, provide solutions to the existing problems associated with image-based colorimetric measurements. In some examples, the proposed color correction system includes a first model (e.g., imaging device coordinate system transformation model) and a second model (e.g., spatial varying coefficient model (SVCM)) to correct color values obtained with the first model that are associated with an object of interest. The proposed color correction system improves the accuracy of colorimetric measurements taken with respect to the object of interest, even under varied lighting conditions.

In one implementation, a smartphone-based solution, that couples a designated color reference board with a color correction algorithm, to achieve accurate and absolute color measurements is described. The color reference board contains multiple color stripes with continuous color sampling at the sides. A correction algorithm utilizes these measurements to leverage both absolute color magnitude and scale with a first-order spatial varying regression model to maximize the correction accuracy. The proposed algorithm is implemented as a smartphone application, which uses an augmented reality scheme through marker-tracking, to guide users taking images at an angle that minimizes the impact of non-Lambertian reflectance. Experimental results show that the colorimetric measurement is device dependent and can reduce up to 90% color variance for images collected under different lighting conditions. In its application to read pH values from test papers, it has been shown that the system performs 200% better than human reading. The designed color reference board, the correction algorithm, and the augmented reality guiding approach form an integrated system as a solution to measure color with increased accuracy. This technique has flexibility to improve color reading performance in systems beyond existing applications, evidenced by both qualitative and quantitative experiments on example applications such as pH-test reading.

The ability to quantify the colors of objects has had many applications in recent years, including calibrating digital screens [1], counting cells [2], pH detection [3], the inspection of contaminated water [4], at-home food colorant measurement [5], colorimetric enzymatic assay [6], and analysis of sweat [7,8] and skin [9,10]. For example, it can be used to measure the total loss of sweat, the rate of sweating, the temperature of sweat, and the concentrations of electrolytes and metabolites in sweat such as chloride, glucose, and lactate [7]. Additionally, accurate color measurement can be used for analyzing the skin lesions such as melanoma and erythema in canine skin [9].

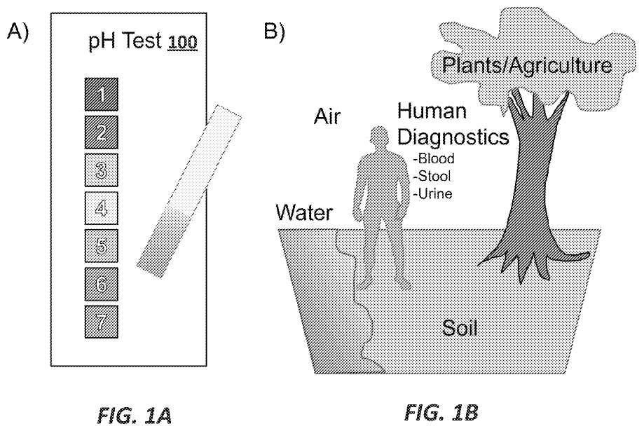

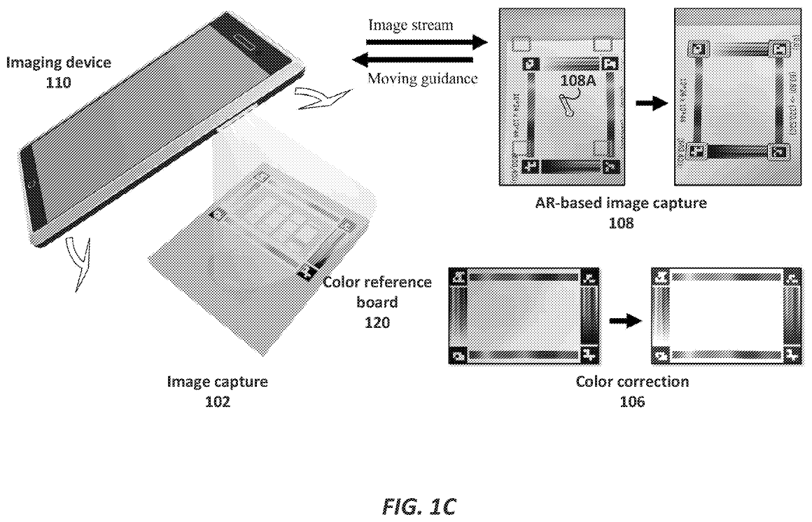

Color-changing test kits can be developed to detect properties of interest in a wide range of media, such as water, air, blood, urine, and others [11]. Usually, these tests require a human to read the colors in comparison to a reference color chart to determine values and positivity (FIG. 1A). The results of human reading may introduce large margins of error due to the biological differences in individuals' color perceptions [12-14]. Up to now, the most rigorous way of identifying the colors of an object is to undergo a laborious color matching test where an operator manually adjusts a mixture of RGB (red, green, and blue) reference light, to perceptually match the color of an object. Reading colors using cameras can be a much less labor-intensive process, and the underlying rationale is to interpret the reflectance of surface material (or the ambient color of the object) from the colors. Due to the varying environment lighting and shadowing effect at data collection, colorimetric measurement requires a process to calibrate the cameras for color reading. This calibration is often performed in a controlled environment (e.g., in the laboratory) where the intensity and the direction of the lighting are known (such as in light chambers [17-19]).

FIG. 1A shows an example pH test kit 100. In some examples, the pH test paper turns blue when exposed to a weak acid solution. FIG. 1B shows examples of properties that a color-changing test kit (e.g., pH test kit 100) can be used to detect.

Nowadays smartphones are regarded as the most commonly used sensor suites [20]. They integrate not only high-resolution cameras but also strong processing powers to facilitate any needed onboard data processing, which makes it a promising platform for accurately quantifying colors at a low cost. As mentioned earlier, reading colors from the camera is a non-trivial task, as it requires a calibration process to overcome the difference of the image sensors and environmental lighting that are otherwise only possibly done in a controlled environment. Typical solutions use a non-parametric approach and require either a one-time or per-capture calibration.

For example, Kong et al. [2] performed a per-capture calibration for single-color shifts using continuous smartphone light emitting diode (LED) as the dominant light source and rescaling the color with the white and black background. Although the results showed that this method can compensate for ambient lighting conditions and reduce variances among different devices, it is limited when the LED is not the dominant light source. In addition, the multiple steps of the process need many manual operations such as aligning the lights, picking, and reading background color for calculation may produce errors and variations in the final results. To reduce calibration effort, Nixon et al. proposed to use a combination of per-sensor calibration and a simpler version of per-capture calibration to obtain device-independent colorimetric readings. The per-capture calibration requires a perfectly aligned image pair with and without a flashlight, to subtract environmental lighting; the per-sensor calibration adopts a collocated discrete color board (with known color values) to correct the sensor-specific tones to achieve “device independence”. Solmaz et al. proposed to use a data-driven approach, i.e., learning from examples using a machine learning model to classify colorimetric tests. This approach cannot predict continuous values and, like many learning-based methods, may suffer from generalization problems [23]. Therefore, optimal solutions must work under general lighting conditions with minimal capture efforts.

Embodiments of the present disclosure propose a novel smartphone-based solution to perform accurate colorimetric measurements of environmental objects. The proposed solution follows a per-capture calibration scheme while proposing a completely new color reference board to capture the heterogeneity of the environmental light to allow spatial varying color corrections. Moreover, the existing methods assume the materials are non-reflective (i.e., assuming the Lambertian Model [24]), embodiments of the present disclosure implement a scheme to address this caveat to alleviate reflective effects. For example, based on the smartphone camera, embodiments of the present disclosure implement an augmented reality-based approach, i.e., a tracking algorithm visualizing moving directions on the camera feed, to guide the users taking the images at a consistent angle to reduce the non-Lambertian effects. In general, embodiments of the present disclosure are highly integrative, consisting of 1) a color reference board, 2) an augmented reality-based image capture module, 3) and a color correction algorithm. The noted system bears a high potential for use in field sampling, telemedicine, and citizen science in addition to lab settings and dramatically increases resolution beyond current methods that rely on human observation. The utility of the solutions presented herein are demonstrated by improving the performance of reading pH test stripes compared to reading by the human eye.

Embodiments of the present disclosure provide a colorimetric measurement system that includes a machine-friendly color reference board and a smartphone application (FIG. 1C). In some implementations, the system consists of three modules: the first module refers to a machine-friendly color reference board, which includes reference colors for correction, and markers for marker localization. The board is flexible and can be adapted to various existing test kits or be integrated into new test kits as discussed in more detail below; the second module refers to an augmented reality-based image capture system, which efficiently processes the camera video feeds to automatically localize the color reference board and compute the position and orientation of the smartphone. This information is used to guide the users in real-time to place the camera at the optimal position to take images at the best angle as described in more detail herein; the third module refers to a color correction algorithm, which corrects the color of the objects using the color from the standard color reference board as further detailed herein.

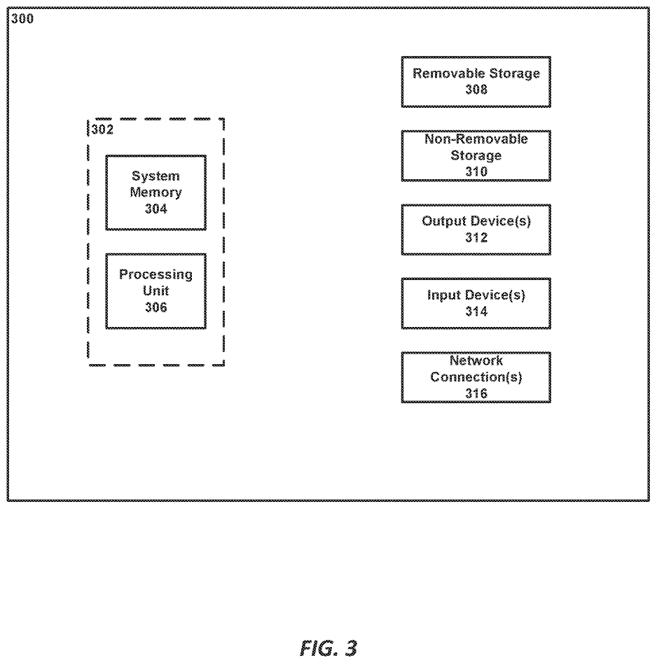

Referring now to FIG. 1C, an example method of color correction for colorimetric measurements is described. This disclosure contemplates that the operations shown in FIG. 1C can be performed using a computing device such as the computing device of FIG. 3. As shown in FIG. 1C, an imaging device 110 is used to capture an image of a color reference board 120. Optionally, the imaging device is a portable electronic device such as a smartphone or tablet computer including a digital camera. It should be understood that smartphones and tablet computers are provided only as examples. This disclosure contemplates capturing an image of the color reference board 120 using any type of imaging device. In implementations where the imaging device is separate from the computing device, the imaging device and computing device can be coupled by a communication link. This disclosure contemplates that the communication links are any suitable communication link. For example, a communication link may be implemented by any medium that facilitates data exchange including, but not limited to, wired, wireless and optical links. Example communication links include, but are not limited to, a local area network (LAN), a wide-area network (WAN), a metropolitan area network (MAN), Ethernet, the Internet, or any other wired or wireless link such as WiFi, WiMax, 3G, 4G, or 5G.

At step 102, an image of the color reference board 120 is received, for example, by a computing device such as the imaging device 110. As described above, in some implementations, the imaging device 110 captures the image.

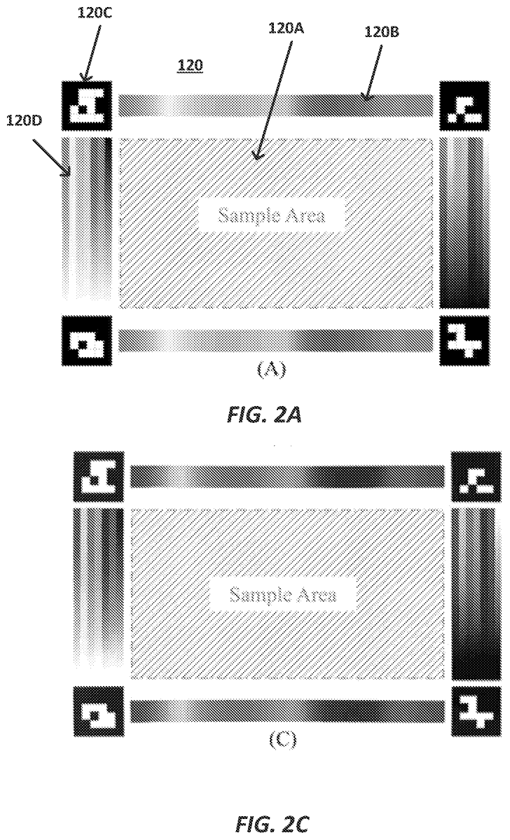

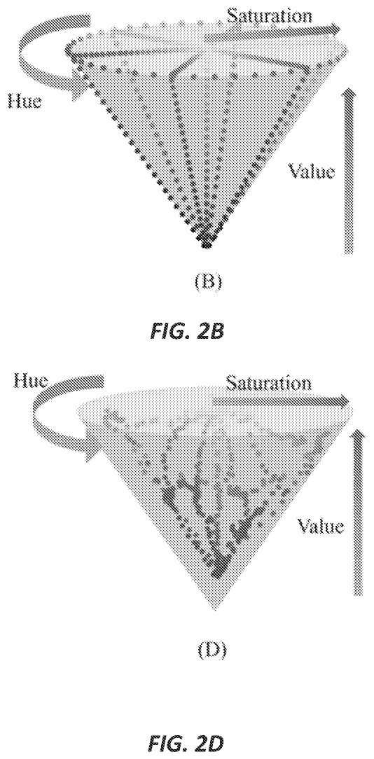

FIG. 2A, FIG. 2B, FIG. 2C, and FIG. 2D illustrate a color reference board and the visualization of sample point in HSV color space. Specifically, FIG. 2A depicts a source file of an example color reference board, FIG. 2B shows source color samples in HSV space, FIG. 2C shows a digitalized file of color reference board, and FIG. 2D shows digitalized color samples in HSV space.

Referring now to FIG. 2A, the color reference board 120 includes a sample region 120A and a calibration region 120B. The sample region 120A is configured to receive an object of interest. For example, the object of interest can be placed on the sample region 120A before image capture. Optionally, the object of interest is a test strip for scientific or medical applications (e.g., pH, chemical concentration, protein concentration, glucose concentration). It should be understood that test strips are provided only as an example object of interest. This disclosure contemplates using the systems and methods described herein in other applications including, but not limited to, calibrating printers and monitors, reading barcodes, making medical diagnoses, agricultural or food safety, environmental monitoring, pathogen surveillance, workplace exposure regulation adherence, chemical exposure monitoring, microbial exposure monitoring, measuring water quality (drinking water, lakes/rivers/oceans, swimming pools, and other), measuring soil quality, or measuring air quality.

Additionally, the calibration region 120B includes at least one color stripe. In some implementations, the color reference board 120 includes a single color stripe. In other implementations, the color reference board 120 includes a plurality of color stripes. As shown in FIG. 2A, the sample region 120A is arranged centrally with respect to the calibration region 120B. In other words, the calibration region 120B surrounds the sample region 120A. It should be understood that the arrangement of the calibration and sample regions in FIG. 2A are provided only as an example. This disclosure contemplates that the calibration and sample regions may be arranged differently than shown in FIG. 2A. For example, the calibration and sample regions may be arranged side by side as a non-limiting example. Additionally, the color stripe or stripes contain a continuous color sampling. For example, the respective color values associated with the at least one color stripe represent a sampling of a color space. Optionally, the color space is defined as a hue, saturation, and value (HSV) space.

Additionally, the color reference board 120 further includes a plurality of coded markers 120C. Optionally, the coded markers 120C include an ArUco marker. It should be understood that the ArUco markers are provided only as an example. This disclosure contemplates using other coded markers including, but not limited to, one-dimensional bar codes, two-dimensional bar codes, QR codes, or other visual markers. As shown in FIG. 2A, each of the color stripes extends between a pair of the coded markers 120C. It should be understood that the number and/or arrangement of the coded markers and color strips in FIG. 2A are provided only as an example. This disclosure contemplates that the color reference card may contain a different number and/or arrangement of coded markers and color strips than shown in FIG. 2A. The color reference board 120 is described in further detail herein.

Referring again to FIG. 1C, a plurality of respective color values associated with the at least one color stripe and the object of interest are obtained from the image. This disclosure contemplates using any known image color extraction procedure such as through standard image reading libraries and functions to obtain color values from the image. Such procedures analyze the image format and obtain, for example, RGB color values. The color values are further processed as described below. At step 106, a color correction algorithm is performed. This includes determining a first model based on respective coordinates associated with the coded markers. Optionally, the first model is a linear transformation model such as a camera coordinate system transformation model. For example, the first model can be defined by Equation 1 below. The color correction algorithm also includes transforming, using the first model, the respective color values and a coordinate grid associated with the object of interest into a plurality of respective adjusted color values and an adjusted coordinate grid associated with the object of interest. An example transformation is from the images shown in 108 to the images shown in 106. The color correction algorithm further includes correcting, using a second model, the respective adjusted color values associated with the object of interest to obtain a plurality of respective corrected color values associated with the object of interest. Optionally, the second model is a spatial varying coefficient mode” (SVCM). Optionally, the second model is a 1st or 2nd order SVCM. For example, a SVCM is provided by Equation 4 below, which also provides example 1st and 2nd order SVCM. The color correction algorithm is described in further detail herein. Thereafter, a colorimetric measurement is performed using the respective corrected color values associated with the object of interest.

Optionally, at step 108, an AR-based image capture process is performed. It should be understood that the AR-based image capture process is performed before the image is captured at step 102. This includes determining, using the coded markers, an optimal image-capture pose relative the color reference board 120 in a three-dimensional (3D) space. Optionally, the process includes tracking the coded markers and/or providing instructions to the user. Instructions may include, but are not limited to, imaging device manipulation instructions and/or image capture instructions. For example, as shown in FIG. 1C, moving guidance is provided to the user during image capture to direct repositioning of the imaging device 110 until the coded markers are aligned with the virtual boxes, at which point the user is instructed to capture the image. Optionally, the optimal image-capture pose is determined by minimizing an effect of reflectance on image capture. Alternatively, or additionally, the optimal image-capture pose is optionally approximately parallel to the color reference board 120. The AR-based image capture process is described in further detail below.

It should be appreciated that the logical operations described herein with respect to the various figures may be implemented (1) as a sequence of computer implemented acts or program modules (i.e., software) running on a computing device (e.g., the computing device described in FIG. 3), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 3, an example computing device 300 upon which the methods described herein may be implemented is illustrated. It should be understood that the example computing device 300 is only one example of a suitable computing environment upon which the methods described herein may be implemented. Optionally, the computing device 300 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 300 typically includes at least one processing unit 306 and system memory 304. Depending on the exact configuration and type of computing device, system memory 304 may be volatile (such as random access memory (RAM)), non-volatile (such as read-only memory (ROM), flash memory, etc.), or some combination of the two. This most basic configuration is illustrated in FIG. 3 by dashed line 302. The processing unit 306 may be a standard programmable processor that performs arithmetic and logic operations necessary for operation of the computing device 300. The computing device 300 may also include a bus or other communication mechanism for communicating information among various components of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate communication of data among the components of the computing device 300. All these devices are well known in the art and need not be discussed at length here.

The processing unit 306 may be configured to execute program code encoded in tangible, computer-readable media. Tangible, computer-readable media refers to any media that is capable of providing data that causes the computing device 300 (i.e., a machine) to operate in a particular fashion. Various computer-readable media may be utilized to provide instructions to the processing unit 306 for execution. Example tangible, computer-readable media may include, but is not limited to, volatile media, non-volatile media, removable media and non-removable media implemented in any method or technology for storage of information such as computer readable instructions, data structures, program modules or other data. System memory 304, removable storage 308, and non-removable storage 310 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 306.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### Design of the Color Reference Board

The design of the color reference board is critical to ensure accurate color determination. In the example shown in FIG. 2A, the coded markers 120C comprise ArUco [25,26] markers employed at each corner of the border. ArUco markers are proven robust for image-based detection and have been widely applied in the field of computer vision and robotics. Additionally, ArUco possesses the following advantages in color reading applications: first, the white/black pattern is robust to various viewing angles and non-uniform illumination; second, based on its binary coding, each ArUco marker can be uniquely identified to represent a different corner of the reference board to facilitate estimating orientations; third, ArUco code advances its alternative—QR code [27] by providing redundant information in its coding, such that the marker is detected when only partial information is present; fourth, ArUco is open-source and its implementation can be easily found and used through well-known computer vision libraries (i.e., OpenCV [28]). Reference color stripes 120D are located along each side of these coded markers 120C, and the sample region 120A defining a central region of the board is used to host the samples. To build an accurate color correction algorithm, the color on the stripes was designed to cover as many visible spectrums as possible (ca. 380-700 nanometers (nm) in wavelength). In some implementations, the color stripes on the sides of the color reference board 120 are rendered by regularly sampling the full (linear) color space determined by this Hue-Saturation-Value (HSV) color model [29] illustrated in FIG. 2B. The stripes at the top and bottom of the color reference board 120 are generated by regularly sampling at an interval of H ∈ [0,1], while keeping the other two components as constants S=1, V=1. The left and right stripes are generated in a similar way with (H ∈ [0,1], S ∈ [0,1], V=1) and (H ∈[0,1], S=1, V ∈ [0,1]) respectively. All the stripes described above serve as the control colors (stripes with known color values in HSV space). All other colors in the space are supposed to be the stable linear combination/interpolation of those sample points surrounding the entire color space. In addition, compared to the additive RGB color model, the HSV color model interprets the color close to human perception (with perceptual attributes, hue, saturation, and value). Although in some other papers, researchers used CIELab color space [30] which is more perpetually linear and covers the entire gamut (range) of human color perception, only part of the space is useful for processing the image in the computer. The 3D geometry of those usable colors is not regular and difficult to use the limited number of color stripes on the test board to represent. In contrast, the HSV color model has a regular cone geometry, allowing for selection of color stripes and sample reference points on them that can not only cover the entire useful color space using limited space on the color reference board but also simulate how human reads color. Using the captured colors (distorted from the standard colors), the color correction algorithm can model the color distortion mathematically to correct the image content. Different designs of the color reference board are proposed by changing the pattern of color stripes and comparing them by analyzing color correction accuracy, as discussed in more detail below. It was found that the design with full HSV color space coverage outperforms other patterns which partially covered HSV color space.

In practice, a standard color reference board with the theoretically correct color can be difficult to achieve, as the varying constraints of printers and their inks may easily distort the colors appearing on reference boards. The color displayed in the source files and the printed color are notably different as can be seen in FIG. 2A and FIG. 2C. If the theoretically designed colors are still corrected, the model will need to involve complicated modeling of the color distortion process of the certain printer, making the problem intractable. Experiments were conducted where instead of taking the theoretical color values appearing in the standard color reference board, as shown in FIG. 2A and FIG. 2B, the color reference board was digitized from the printed material by scanning with a common smartphone app and reassigning the color values of the standard color reference board based on the digitalized (scanned) printed color reference board as the intermediate color system. Empirically this was found to be effective to adapt the standard color reference board by users with different printers.

### Augmented Reality-Based Image Capture Guidance Module

A “human-in-the-loop” process was designed to standardize the image capture practice to alleviate possible errors due to inconsistent collection angles and illumination. An augmented reality-based module is proposed and implemented to guide the users to acquire images that are consistent in viewing angle. For example, with the ArUco markers, an optimal photo-taking pose in 3D space can be defined related to the color reference board and guide users to approximate the same collection angle. By fixing the capturing angle as much as possible, the system inherently separates possible non-Lambertian surfaces (such as reflective surfaces). The algorithm starts by estimating the position of the camera (location and facing/orientation) when the users attempt to capture the image. This is done by computing the difference between the estimated orientation and the desired one. A correcting direction appearing will be computed and visualized as an arrow in the center of the image frame. An example arrow 108A is shown in FIG. 1C. This arrow 108A guides the user to adjust the orientation of the camera until the arrow is minimized, followed by an automatic shuttering to take the desired image. A more detailed algorithmic flow is shown in FIG. 4 which depicts a workflow of an example augmented reality-based image capture module in accordance with certain embodiments of the present disclosure. As shown, the system comprises of a marker tracking submodule 402, a pose solver 404, and an AR-based guiding submodule 406. The marker tracking submodule 402 keeps the markers in track as the user moves and it can provide up to 16 very stable key points for localization, noting that only minimally three points are needed. The pose solver 404 takes the 16 key points from the tracking module, to compute the relative position and orientation of the camera using the 3D computer vision method. As mentioned above, the 16 points provide additional redundancy over the three minimally needed points to ensure robust and accurate pose estimation. The augmented reality-based guiding submodule 406 serves as the final gatekeeper and decides whether or not to accept an image as the final candidate using the desired angle and position as the key criterion. Each submodule is described in more detail below in the order of the processing sequence.

### Markers Tracking Submodule

The goal of the markers tracking submodule 402 is to detect the pixel locations of up to 16 key points (e.g., 4 corners of coded markers such as, but not limited to, 4 ArUco markers) on a given image. The detection procedure that was used directly inherits existing implementations in open-source computer vision packages (e.g., OpenCV [28]). The parameters of these elementary processing algorithms have been carefully tweaked to twin the detection with the standard ArUco code. This detection procedure of ArUco markers is composed of a series of mature image processing methods. More details can be found in [31].

The process encounters limitations intrinsic to the mobile platform, such as its limited computing power and incurred battery use. Thus, executing ArUco detection for every frame can be suboptimal leading to not only a quickly drained battery but also degraded user experience due to the delay. To improve the time efficiency of the system, a lightweight tracking algorithm is proposed to speed up pixel localization by exploring the temporal coherence between video frames.

Since the video stream at image capture takes up to 30 frames per second (fps), it is expected that there will be minimal motion between temporally adjacent frames (with a time difference of only 33 milliseconds) at the scale of a few pixels. Therefore, in the example algorithm described herein, instead of detecting the key points for every frame, the key point detector is applied to a single frame, followed by a local and fast pixel tracker called pyramid Lucas-Kanade optical flow [32] (PLK), to track these points. ArUco detection will be executed again on new frames if the PLK algorithm fails to track all the key points due to out-of-boundary feature points or sudden camera motion. Additionally, the tracking algorithm might be subject to an accumulation of errors [33]. To ensure the robustness of the algorithm, the PLK algorithm will only be used when 16 key points are detected. With the hybrid detection and tracking method described herein, the framerate for point detection and camera pose computation was improved from 25 fps to 60 fps on the test phone, equivalent to a 140% improvement.

### Pose Solver Submodule

For each frame, the key points were used (either detected or tracked from the markers tracking submodule 402) as the input, to estimate the location of the image with respect to the world coordinate system (defined by the marker of the test badge, the printed color reference board 120 described herein). Given a key point location (denoted as Pᵢ ∈ R²) from an image frame, the corresponding world location of the key point is also known to be on the test badge. Therefore, these key points can be used to recover the coordinate transformations between the image location and the predefined world location. FIG. 1 is a schematic illustration showing definitions of coordinate frames in a system in accordance with certain embodiments of the present disclosure. The 2D image frame is composed of the x and y-axis of the camera coordinate system. The acceptance region refers to a region where camera placement is acceptable for image capture, determined as an area around the computed optimal camera placement position.

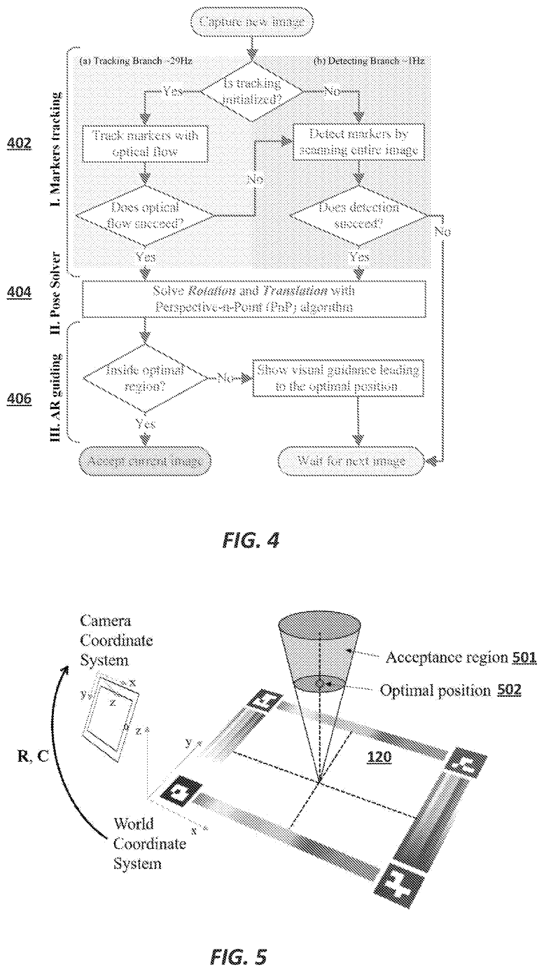

As shown in FIG. 5, the origin of the world coordinate system is defined at the bottom left corner of the color reference board 120, with axes x-right, y-up, and z-axis following the right-hand rule. The color reference board lies on the XOY plane of the world coordinate system, and the world coordinates of the key points are denoted as Pᵢ^{w} ∈R³.

The relative pose (transformation) between the world coordinate system and image coordinate system can be interpreted as a homography [34] transformation (a delineating 3×3 projective transformation with eight degrees of freedom) including a rotation matrix (R) and a translation vector (C) as shown in FIG. 5, and a pinhole camera intrinsic matrix (K). The transformation is described in Equation 1.

$$s [ \begin{matrix}{P}_{i} \\ 1\end{matrix} ] = K \times R \times ( {P}_{i}^{w} - C ) \qquad ( 1 )$$

where s denotes the scale factor in the similarity transformation, K ∈ R^{3×3} denotes the pinhole camera intrinsic matrix, R ∈ R^{3×3} denotes rotation transformation matrix and C ∈ R³ denotes translation (camera center in world coordinate system). Readers may refer to for details about the camera matrix. It is possible that a more complex model (i.e., non-linear transformation), may occasionally achieve better results if the camera lens is heavily distorted, but it would not be generalized to all cases, and will likely fit noises in the model.

In general, the intrinsic matrix K needs to be pre-calibrated for every camera. Fortunately, most smartphone manufacturers provide calibration matrix and built-in lens distortion removal through their SDK (Standard Development Kit) [36,37], which can be directly inherited used. Finally, the fast and robust Perspective-n-Point (PnP) algorithm [38] is used to solve rotation R and translation C from at least 3 (Pᵢ, Pᵢ^{w}) pairs.

### Augmented Reality-Based Guiding Submodule for Image Capturing

The optimal camera position is defined to be parallel to the color reference board 120, viewing from the top (shown as optimal position 502 in FIG. 5). With this orientation, the camera can capture the most details of the board and minimize perspective distortions. Some earlier works suggested 45 degrees as the optimal viewing angle [21], as it can minimize the specular reflectance and ambient light while using a flashlight as the light source sideways. However, in the disclosed system, using a viewing angle of 90 degrees favors Lambertian surfaces and maximizes the resolution that brings added benefits, as discussed in more detail below.

The best capturing distance of the camera should be optimized based on the resolution and the coverage of the color reference board. Thus, using simple similarity triangles, the optimal height is defined by Equation 2 as follows:

$$\frac{focal}{optimal height} = min ( \frac{{W}_{image}}{{W}_{board}} , \frac{{H}_{image}}{{H}_{board}} ) \qquad ( 2 )$$

where focal is the focal length in pixel unit. W_{image} and H_{image} are the width and height of the image plane in pixel unit. W_{board} and H_{board} are dimensions of the color reference board in the world unit. The optimal height is defined in the world unit.

A small window around the optimal pose is tolerated to allow a certain error margin for camera placement, which is identified as the acceptance region 501 as shown in FIG. 5. The optimal point is set as ϵ=20 pixels around the optimal point. As for height tolerance, the smartphone is allowed to be at 1.0~1.5 times optimal height, which yields images where the color reference board is properly located with sufficient resolution.

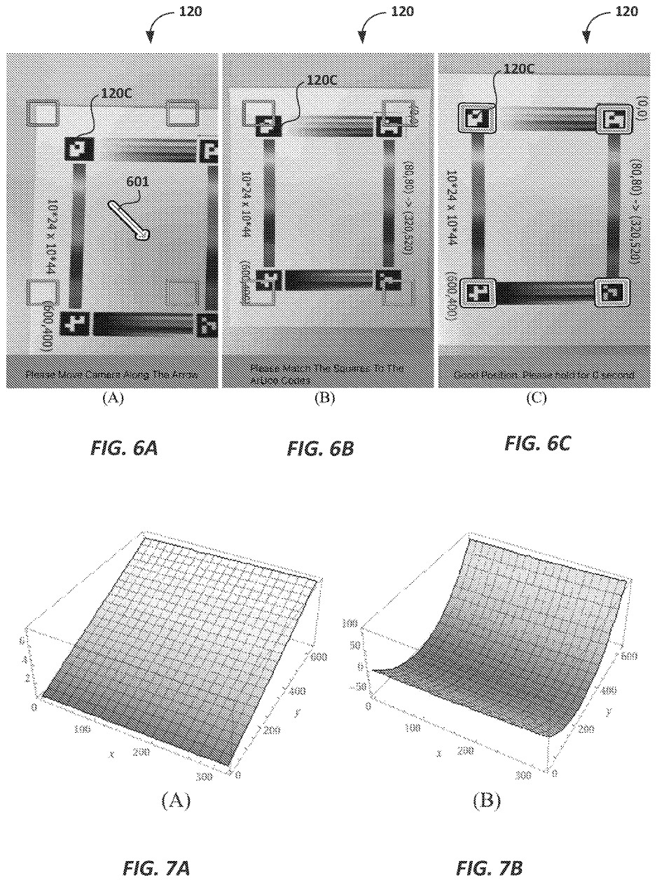

FIG. 2A, FIG. 6B, and FIG. 6C provide an operational example of using the augmented reality-based visual guidance module. FIG. 6A is a screenshot of the application (App) at image capture, in which the users are asked to follow a yellow arrow 601 to reach the optimal pose. FIG. 6B depicts the frame adjusted to align the square templates to the coded markers 120C (e.g., ArUco markers). In FIG. 6C, the system confirms the accepted pose by turning the markers green, followed by automatically triggering the shutter to take the images.

Given the target camera pose (i.e., optimal pose), the disclosed system provides visual guidance displayed in the video feed to allow the users to adjust the camera location. As shown in FIG. 6A, four marked corners are showing the intended alignment to the coded markers 120C (e.g., ArUco codes), as well as the yellow arrow 601 indicating the direction and distance the camera should move. Texts and audio guidance is also provided for visually impaired people (shown at the bottom of the images in FIG. 6A, FIG. 6B, and FIG. 6C). As the user moves the camera closer to the optimal poses, the arrow will become shorter. Once the arrow is short enough, the user can align the red squares on the four corners of the screen to the plurality of coded markers 120C (e.g., the four ArUco codes) on the color reference board 120 to perform the height adjustment until reaching the preset tolerance (as shown in FIG. 6B). After this, the red squares will turn to green, and the system will advise the users to hold for one second till it automatically triggers the shutter to take a photo (as shown in FIG. 6C). Image content outside of the color reference board 120 will be automatically cropped to preserve privacy and be rectified to orthogonal views for further image analysis.

### The Color Correction Algorithm

Once the image is captured, a color correction algorithm is used to perform the color correction using the reference color on the sides of the color reference board 120. In some implementations, a linear transformation transforms the color from the side color bars to their pre-recorded reference values, and the goal is to apply the same transformation to the object of interest in the image (in the sample region). Assuming a linear transformation, a transformation called simple linear model is formulated as in Equation 3.

$${I}_{ref}^{c} = {α}^{c} \times {I}_{image}^{c} + {β}^{c} + e , c ∈ \{ R , G , B \} \qquad ( 3 )$$

where c represents the channel of the image. I_{ref}^{c} refers to the expected color intensity of a point on the color stripe, and I_{image} ^{c}refers to the color intensity value from the captured image. A^{c} and β^{c} are linear coefficients for this linear model, e is the error term. However, in an indoor and complex environment, merely using a simple linear model may not yield satisfactory results, as the direction and intensity of light are heterogeneous. Therefore, the uneven lighting effects are modeled using a spatial varying coefficient model (SVCM) as shown in Equation 4, where the linear coefficients α^{c} and β^{c} are correlated with the location of the pixels.

$${I}_{ref}^{c} ( x , y ) = {α}^{c} ( x , y ) \times {I}_{image}^{c} ( x , y ) + {β}^{c} ( x , y ) + e \cdot c ∈ \{ R , G , B \} \qquad ( 4 )$$

To compute the spatially varying coefficient models, a first or second order function is proposed to fit α\hat{ }c (x,y) and β\hat{ }c (x,y), taking the observed color stripes and their reference values as the observations. FIG. 7A and FIG. 7B show examples of parametric 2d-spatial varying functions. In particular, FIG. 7A depicts a 1^{st} order (primary) surface with three parameters—f₁(x, y)=ax+by +c; and FIG. 7B depicts a 2^{nd} order (quadric) surface with 6 parameters—f₂(x, y)=ax²+bxy+cy²+lx+my+n. On the one hand, it is assumed that the light variances can be modeled by a first-order function due to the small physical size of the test badge. On the other hand, this simple and first-order model can produce more robust results and is less likely to produce overfitting problems. More models are tested as reported below, including the simple linear model, the spatial varying coefficient models using first and second order functions to fit the coefficients, and non-parametric models.

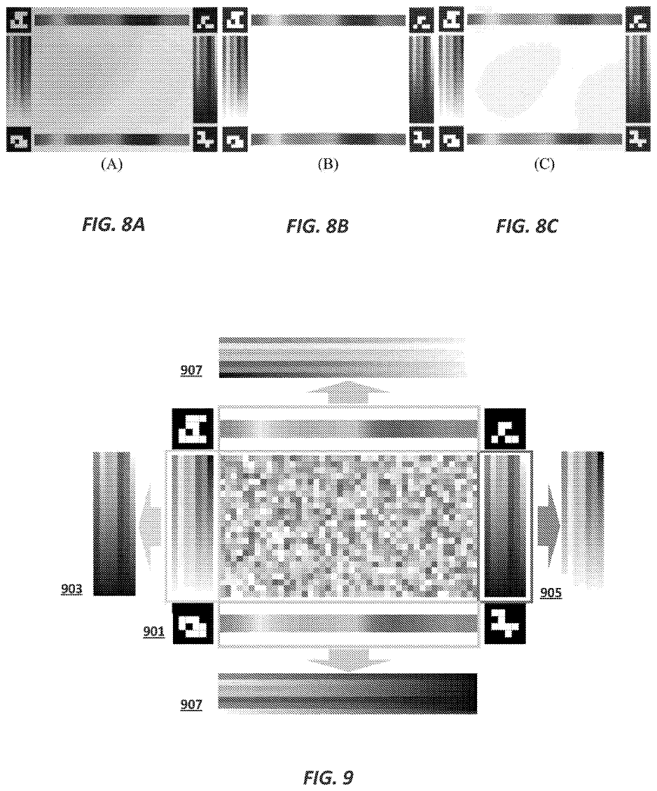

Spatially varying coefficient models can be fitted by using ordinary least squares (OLS) [41]. Specifically, corresponding pairs of points were sampled with 10-pixel intervals on the color stripes on both captured image and standard color reference board (digitalized from printed color reference board), in a total of 424 pairs. The colors of those pairs were used to fit the first-order SVCM using OLS. The model was fitted for each channel (red, green, and blue) separately. Then the color of the entire captured image was corrected by applying those 3 models to all the pixels of the corresponding channel. FIG. 8A, FIG. 8B, and FIG. 8C present an operational example of applying color correction algorithm (with primary surface function ƒ₁). In FIG. 8A, the image is taken under the uneven room light by the smartphone, then cropped and rectified using the method described above. It can be seen that there is a gradual change in illumination in the original image. After applying the correction model, the resulting corrected image in FIG. 8C is shown to be more similar to a standard color reference board shown in FIG. 8B.

### Experimental Results

The results of two simulated experiments and two real (physical) experiments to verify the proposed system are discussed below. In the simulated experiments, an “object of interest” at the center of the color reference board is synthesized to quantitatively examine the color correction algorithm. In real experiments, firstly, an object was independently captured, and the difference was compared after the correction to validate the effectiveness of the proposed solution. Secondly, a pH test paper reading experiment was designed to demonstrate the practical value of the proposed system.

### Synthetic Experiments

The algorithm is evaluated with the randomly generated 44×24 color mosaics and sampled one pixel for each mosaic to cover the potential color space as shown in FIG. 9. The mean root mean squared error (mRMSE) is used over the RGB channels to quantitatively evaluate the performance of the algorithm (Equation 5 below). Compared to other metrics, such as mean absolute percentage error (MAPE), RMSE measures the absolute differences and does not impose a biased assessment for different color values, which is preferred in the conducted experiments. Then different combinations of color stripe patterns were tested in the badge design and color correction models to understand if other variants of combinations of color patterns and color correction models may lead to better results. Additionally, a simulated experiment was run by finding the optimal pose of the camera for correction, all using the synthesized “object of interest”.

FIG. 3 depicts a rendered color mosaic and designs of color reference board and shows: a first color stripe pattern 901 (a combination of Hue, Saturation, and Value stripes), a second color stripe pattern 903 (a combination of Hue and Value stripes), a third color stripe pattern 905 (a combination of Hue and Saturation stripes), and a fourth color stripe pattern 907 (a combination of Saturation and Value stripes).

$$m R M S E = \frac{1}{3} {\sum }_{c}^{c ∈ \{ R , B , G \}} {RMSE}^{c} , \qquad ( 5 )$$

$$where {RMSE}^{c} = \frac{1}{\sqrt{W \times H}} \sqrt{{\sum }_{x}^{W} {\sum }_{y}^{H} {( {I}_{ref}^{c} ( x , y ) - {I}_{corr}^{c} ( x , y ) )}^{2}} , c ∈ \{ R , G , B \}$$

where W and H are the width and height of the image, I_{ref}^{c} is the pixel value of channel c on the image pixel value of the standard color reference board, respectively, I_{corr}^{c} is the value of the color-corrected image.

### Impact of Different Color Stripe Patterns and Color Correction Models On the Reference Board

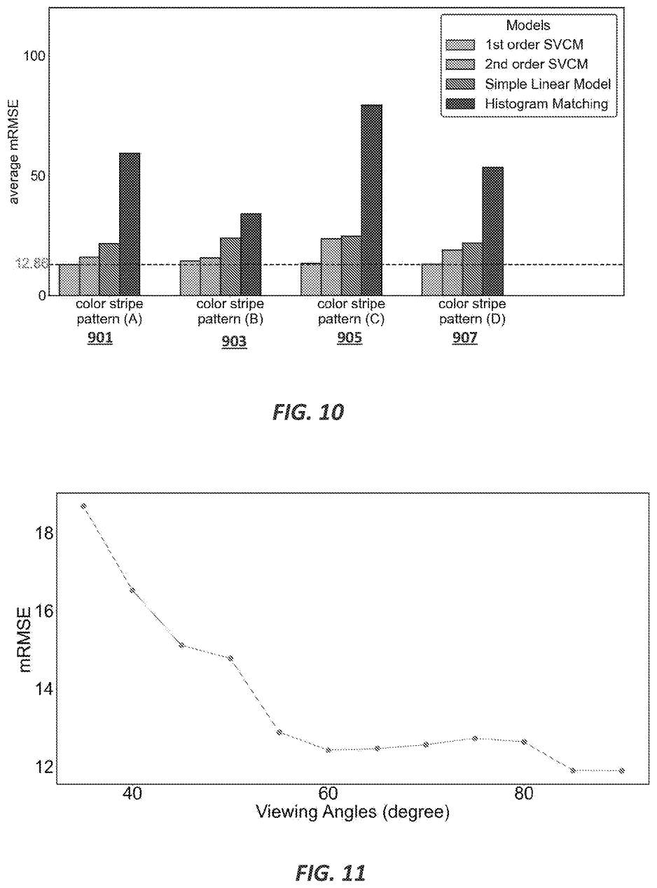

In this experiment, three variants of patterns of the color stripes and four-color correction models were compared to study 1) the sensitivity to results for different color stripe patterns, and 2) other correction models in addition to the linear SVCM model. The performance is evaluated by mRMSE computed from the generated color mosaic (FIG. 9). The color reference board (first color stripe pattern 901 in FIG. 9) presented in previous sections consists of three kinds of color stripes groups: the Saturation stripes on the left side in the yellow rectangle (H ∈ [0,1], S ∈ [0,1], V=1); the Value stripes on the right in the blue rectangle (H ∈ [0,1], S=1, V ∈ [0,1]) and the Hue changing stripes on the top and bottom in the green rectangle (H ∈ [0,1], S=1, V=1). Three variants of the patterns were derived with different combinations as shown in FIG. 9: a second color stripe pattern 903 variant with Saturation fixed stripes, third color stripe pattern 905 variant with Value fixed stripes, and fourth color stripe pattern 907 variant with the Hue fixed stripes. As for color correction models, the 1st order and 2nd order spatial varying coefficient model (SVCM) were compared with a simple linear model without spatial varying coefficient and a non-parametric method called histogram matching [42]. Results are presented in FIG. 10 which shows the performance of different combinations of color stripe patterns and models. The image is taken under 3 different color temperatures (2800k, 4000k, and 6500k) and with 3 different lighting directions, and the average mRMSE is taken from 9 readings.

FIG. 10 shows that the color stripe pattern 901 with 1^{st} order spatial varying coefficient model achieves the least mRMSE=12.86. which were used for the rest of the experiments. First color stripe pattern 901 has all the components of the HSV space that encapsulate the full range of colors. This is evidenced by the fact that generally, all the models perform the best for the first color stripe pattern 901, with the exception that the histogram matching method performs variably with different designs but is poorer than the other models. The parametric models perform similarly with first color stripe pattern 901 and fourth color stripe pattern 907, with the fourth color stripe pattern 907 marginally better, meaning that the Hue channel is least informative for color correction.

### Optimal Viewing Angle

In this section, the effect of different viewing angles on color correction accuracy was analyzed to determine the optimal viewing angle in the AR guiding submodule. Images are rendered with viewing angles from 35 to 90 degrees with a 5-degree step, for each image, its mRMSE is evaluated using its ground truth color to understand how the accuracy changes with respect to the angles. During the experiments, a Lambertian surface was assumed (the most common one in the natural world), and the results are shown in FIG. 11 which depicts the curve of mRMSE vs viewing angles. As can be seen, the accuracy increases almost monotonically as the view angle approaches 90 degrees. Specifically, mRMSE over RGB channels gradually decreases as the viewing angle increases. 90 degrees means the camera is right above the board.

Comparison with Other Colorimetric Measurement Methods

In this section, a traditional color correction method using a color checker called “color checker correction” and two recent colorimetric measurement methods mentioned above are compared with the proposed system.

Traditional correction method associated with a color checker uses the simple linear model in Equation 3 to achieve color correction. The difference is that the I_{ref}^{c} refers to the expected color value of a patch on the color checker, and I_{image}^{c} refers to the color value from the captured image of the color checker. This kind of correction does not account for heterogeneous lighting effects over different parts of the object. A color checker may work to a degree that the corrections are accurate in the vicinity of the color checker. As an analogy, the color correction algorithm with the color reference board is close to using multiple color checkers in the space and applying different correction coefficients for each. Essentially this is done by using full color-space with a spatial varying function to ensure continuity in the functional space. In this experiment, only 24 points were sampled from the stripes to simulate the color checker.

Both recent colorimetric measurement methods involve the use of specific hardware and software, so reproducing them exactly can be challenging; however, the comparative study was conducted as fairly as possible. Since codes are not available for these methods, they were reimplemented based on the paper. One of them is from [2], where the authors used the flashlight on the smartphone as the dominant light source and rescaled the color with the white and black background, notated as “Flashlight rescale”. The other is from [21], where the flashlight was used to remove the environmental lighting, and the color checker was used to fit a mapping from RGB to CIE XYZ space to achieve device-independent, notated as “Flashlight color checker correction”. As for the Flashlight color checker correction method, the system was simplified by removing the Intensity Non-Uniformity Correction (INUC). In addition, after transferring the RGB values to the CIEXYZ color space with fitted mapping, the values were converted back to RGB for evaluation and visualization with the default transformation between RGB and CIEXYZ.

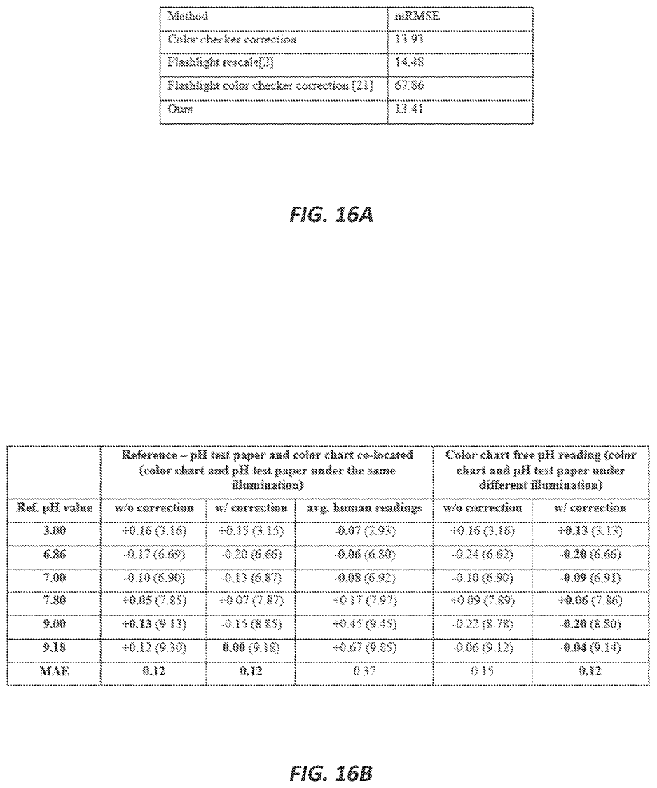

In this experiment, the images of the printed color reference board were taken under a fluorescent lamp in the lab with the iPhone SE2 and did not consider the different devices. For both recent methods which used a flashlight as an additional light source, the images were taken perpendicular to the color reference board (right above the board). Then the region with strong reflection, which looked like a bright white spot at the center, was ignored during evaluation. For all methods, the standard colors for evaluation were from the digitalized printed color reference board. The mRMSE and images for different methods are shown in FIG. 16A which is a table showing a comparison of different colorimetric measurement methods.

Compared to the Color checker correction method which was built on the color reference board with a simulated color checker from the stripes, the proposed method with the first-order SVCM can address uneven lights on the objects and achieve lower mRMSE. The Flashlight rescale method has higher mRMSE than the proposed method. In addition, this method relies much on the manual selection of the black and white reference points. The Flashlight color checker correction method has much higher mRMSE on the validation points. The possible reason for this is that the assumption that the response of sensors across the three channels is linear with increasing intensity is not always achievable or too strict to fulfill. Compared to those recent methods, the system described herein is much more user-friendly with much more flexibility and better correction performance.

### Real-World Experiments

The performance of the color correction algorithm is evaluated through two real-world experiments: 1) device-independent object color correction under varying lighting conditions, and 2) a pH reading experiment comparing the colorimetric pH measurement algorithm with human eye readings.

### Device-Independent Color Correction

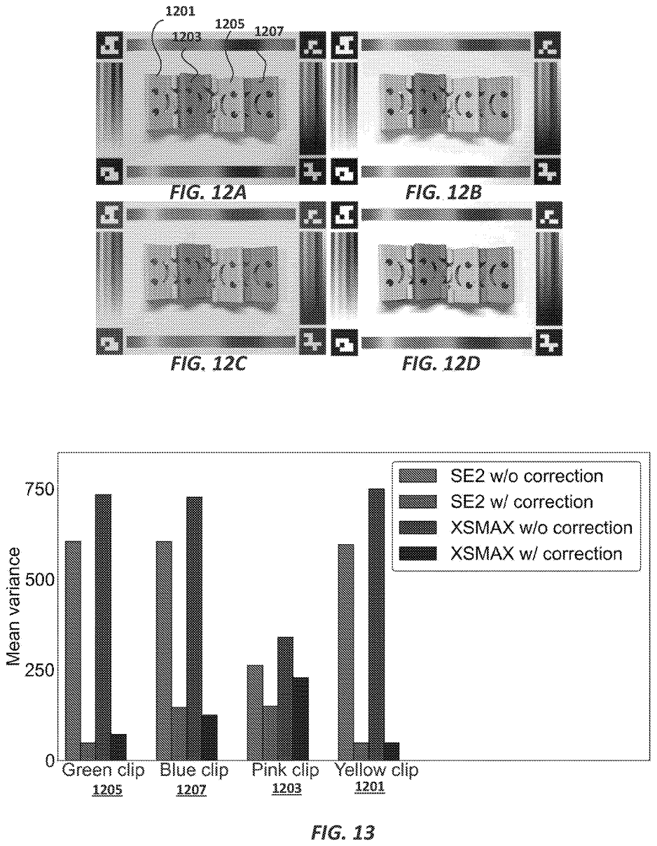

In this experiment, images were taken of objects with cameras of two mobile phone models (iPhone SE 2^{nd} generation (released in 2020) and iphone XSMAX (released in 2018)) under 15 different lighting conditions. FIG. 12A and FIG. 12C show images taken under two different mixed lights by iPhone SE 2^{nd} generation and iphone XSMAX, respectively. FIG. 12B and FIG. 12D are the corresponding images after color correction. The goal is to measure the color differences of the object under different lights and cameras before and after the color correction. Ideally, the corrected colors of the objects are expected to be consistent despite the original images being captured under different lighting conditions and cameras. To facilitate the evaluation, a few binder clips with distinctively different colors were lined up in a row, such that the before- and after-correction can be easily quantified. With reference to FIG. 12A, a yellow clip 1201, pink clip 1203, green clip 1205, and blue clip 1207 were used. As noted above, FIG. 4A-D show example images under different lights and camera and their correction results. Two examples of these uncorrected images are shown in FIG. 12A and FIG. 12C, and their respectively corrected images are shown in FIG. 12B and FIG. 12D.

The strong visual comparison demonstrated that the correction algorithms can yield visually consistent images of the same objects, despite these images being taken under distinctively different lighting conditions and cameras. The variance of the 15 images was computed from each smartphone, for each color clip. The same variance is calculated for images after the color correction.

FIG. 5 is a graph showing color correction performance of different binder clips. It was shown in FIG. 13 that the corrected images have a much smaller variance, approximately at a factor of up to 15 times. It was also observed that the level of improved color consistency is correlated with the color to be corrected, for example, the pink clip 1203 has less improvement than the other three, which might be due to its already small color variance before the correction.

Comparison of Colorimetric pH Measurement Algorithm with Human Eye Readings of pH Stripes

Experiment setup. A pH test paper reading experiment was designed to quantitatively compare the proposed colorimetric pH measurement algorithm with human eye readings. In this experiment, six pH buffers (3.0, 6.86, 7.0, 7.8, 9.0, and 9.18), and 3 different kinds of standard pH test paper and reference color chart covering pH ranges of 3-5.5, 6-8, and 8-9.5 (Fisher Scientific, Pittsburgh, PA), were tested separately. Except for the buffer with pH 7.8, all other buffers were commercially obtained colorless reference buffers (Fisher Scientific, Pittsburgh, PA). The buffer with a pH of 7.8 was prepared by combining 3.68 mL 1 M potassium phosphate dibasic (K₂HPO₄, CAS #7758 Nov. 4), 1.32 mL 1 M potassium phosphate monobasic (KH₂PO₄, CAS #7778-77-0) and 45 mL DI water (18.2 MΩ cm) [43]. The pH of the buffer was measured with an Orion 5-Star portable meter equipped with a pH combination electrode (Cat. no. 9107APMD, Fisher Scientific, Pittsburgh, PA), and adjusted as necessary with 1M potassium phosphate dibasic or monobasic. Six participants were invited without self-reported visual impairments related to color perception to do the human eye readings; their ages were estimated to be between 18-40 years old. The human eye reading vs colorimetric pH measurement algorithm experiment was organized as follows.

The entire experiment was carried out on a large laboratory bench under bright fluorescent light. Freshly poured aliquots of the pH buffers were placed behind a screen to obstruct them from the view of the participants during preparation. The participants were allowed to enter, received instructions, and lined up to take readings. For each of the six trials lasting approximately 3-5 minutes, the pH paper was dipped into the unknown buffer while obstructed from view, placed in the center of a color reference board, photographed with the iPhone SE 2^{nd} generation, and then shown to the participants for pH estimation. Participants read the pH values of pH paper by comparing the color of pH test papers to the reference color chart. The readings were performed individually by each participant without sharing or discussing results with the others. To minimize bias, the sequence of the pH buffers was arranged such that buffers with values close to one another were not read consecutively (e.g., pH 9 and 9.18), and the participants were instructed to line up in random order for each reading. In parallel, based on the proposed color correction system, a colorimetric pH measurement algorithm was designed that will read the color from the images of the pH test paper and the reference color chart. Then the algorithm will measure the pH by comparing colors (details in the next subsection). To minimize light and shadow inter-trial variability, each photograph and human reading were collected in the same respective locations on the bench, i.e., the light condition was kept the same. So, this is also called the experiment reference case.

An additional experiment was conducted without human readings where the images of the reference color chart were taken under a different light condition (outside sunlight) from where the images of pH test paper were taken (in the laboratory). In this additional experiment, it was demonstrated that the proposed color correction system can improve the colorimetric measurement accuracy when the color changes under different light conditions. This characteristic has much practical value in that manufacturers do not need to offer the physical color reference chart but can encode a digital copy of the color reference in the mobile app. It not only saves the user's reading step but can standardize the reading process to improve accuracy. During actual usage, users just need to take an image of the pH test paper using the mobile phone, the color will be corrected, and an accurate pH value will be measured. Thus, this additional experiment is referred to as color chart free case. This characteristic can also facilitate many other colorimetric measurement applications.

The above experiments were approved by the Ohio State University Institutional Review Board, study number 2022E0482. Consent was obtained via an online unsigned script to avoid linking participants to their responses. Participants checked “yes” to consent and then entered their readings in an online survey on the next page.

Colorimetric pH measurement algorithm. FIG. 6 shows an example cropped and rectified image of a reference card and test paper including a reference card 1402 and a test paper 1404 reacted with a sample whose pH=7.0. Here, the brand of the test paper is blocked with a white box over that part of the image.

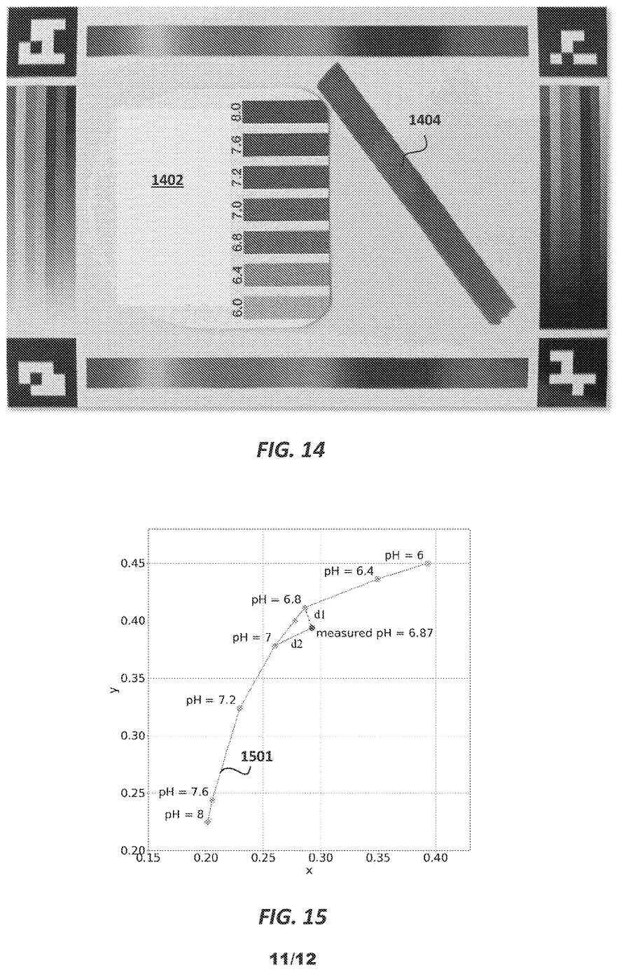

As shown in FIG. 14, the pH test paper 1404 reacted with the solution which has a pH value of 7.0, and the corresponding color reference chart covers the range from 6-8. Since the color chart only resolves discrete pH values (at an interval/resolution of 0.2-0.4), to determine the color beyond this resolution, the pH value of the measured color of the pH test paper is interpolated by using the inverse distance weighting (IDW) method to the two closest data points on the color chart.

FIG. 7 illustrates a pH value interpolation method. The curve was built from the reference color chart 1501 (blue line). The measured color of reacted pH test paper may not perfectly lay on the reference curve (point outside curve). The distances to the two closest reference points (pH=6.8 and 7), d1 and d2 are found. Then the pH value is interpolated by applying the IDW method: measured pH=(6.8×d2+7×d1)/(d1+d2). Then the line segment is split from 6.8 to 7 with the ratio d1/d2 to get the point of the final measured pH value on the curve. As further depicted in FIG. 15: each green point presents the reference color to a pH value on the color chart. The blue point is a measured color from the pH test paper. By determining its color difference to each of the reference colors on the color chart, the nearest two reference points (green) are identified and linked to the measured point (blue) via red lines. A weighted average is computed to determine the final measured pH value (orange point) that lies between the two reference points, and the weights are inversely proportional to the color difference. Following the most common practice in colorimetric pH test paper reading [21,45], chromaticity x and y derived from International Commission on Illumination (CIE) 1931 XYZ color space were used to define the color reference curve and interpolate for measurements. Using this process, pH values beyond the color chart resolution were determined.

pH reading experiment results. The experiment results are reported in FIG. 16B which is a table showing pH errors and values measured by human observers and smartphone apps with and without the proposed correction algorithm under different lighting conditions. It includes the results of two experiments, 1) reference case, where the color chart and the pH test paper are captured together in the laboratory where participants read the pH. In this case, the proposed colorimetric pH measurement algorithm is compared with human eye readings; and 2) the color chart free case, where the color charts and the pH test paper are separately captured. In this case, the performance of the proposed algorithm is compared when the input images are from similar or dramatically different light conditions (laboratory vs outside sunlight).

From the results of the reference case, in general, human readings performed well on solutions that have a clear reference reading in the color charts (e.g., solutions of 3.00, 6.86, 7.00), but worse on reading pH test paper of solutions beyond the resolution of the charts (e.g., solutions of 7.80, 9.18). As a result, the human readings achieved a Mean Average Error (MAE) of 0.37. In contrast, the readings determined by the proposed algorithm show stable performance on all solutions and achieved a Mean Average Error of 0.12, three times better than human reading. From the results of chart free case, the Mean Average Error of the pH reading decreased from 0.15 to 0.12 as the color correction algorithm is applied. This error is also consistent with the reference case where the color charts and the pH test papers are taken under the same illumination.

Those observations conclude that firstly, the proposed system can achieve approximately tripled accuracy as compared to human eye readings. Secondly, it also has the ability to extrapolate reading beyond the resolution of reference charts. Thirdly, it can accurately measure color under different lighting environments and the manufacturer does not need to offer a physical color reference chart to users.

Due to the high prevalence of visual impairment, which affects some 285 million people worldwide [47], the sample of research participants represents an underrepresentation of human accuracy issues and the proposed solution improves the accessibility of colorimetric measurement for people with visual disabilities.

### CONCLUSION

A novel smartphone-based solution for accurate colorimetric measurement is proposed. It consists of a novel color reference board, with an augmented-reality (AR) guiding system, and a novel color correction algorithm. The color reference board is designed to cover the full visible color space to provide an absolute reference of colors to determine the color values. The AR guiding system introduces the “human-in-the-loop” process to capture images with the desired camera position and viewing angle to reduce the impact of various lighting reflecting effects. A novel color correction algorithm with the first-order spatial varying coefficient model is proposed to couple the color stripes on the reference board, to provide effective color corrections to recover the colors distorted by the device and environmental lighting. Both simulated and real data experiments were performed, which include testing samples simulated through computer graphics-based rendering, real object color correction as well as pH reading from color stripe kits. These experiments suggest that the proposed system is able to capture color consistent images under varying lighting environments and devices, which effectively reduces the color variances up to a factor of 15. Specifically, the pH reading experiment demonstrates that, regardless of varying lighting conditions, the proposed system can achieve pH readings three times more accurately than human reading and can effectively determine pH values that are beyond the resolution of the reference color chart of the pH test kits.

Overall, these improvements in color determination have broad implications for improvements in a wide range of applications, including medical diagnostic tests, environmental monitoring, and agricultural applications. The system also improves the accessibility to accurately read colors for those with visual impairment. Future work will consider developing more advanced color correction models that address partial shadow problems at data capture in cluttered environments, as well as extend the current system to an Android implementation for scalability and enabling more applications. The system can also be applied and adapted to broader applications such as medical diagnostician tests, environmental monitoring, and agricultural applications.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The following patents, applications, and publications, as listed below and throughout this document, are hereby incorporated by reference in their entirety herein.

### REFERENCES

1. Lin Z, Ma Q, Zhang Y. PsyCalibrator: an open-source package for display gamma calibration and luminance and color measurement. 2021;
2. Kong T, You J B, Zhang B, Nguyen B, Tarlan F, Jarvi K, et al. Accessory-free quantitative smartphone imaging of colorimetric paper-based assays. Lab Chip. 2019; 19 (11): 1991-9.
3. Kim S D, Koo Y, Yun Y. A smartphone-based automatic measurement method for colorimetric pH detection using a color adaptation algorithm. Sensors. 2017; 17 (7): 1604.
4. Shrivas K, Patel S, Sinha D, Thakur S S, Patle T K, Kant T, et al. Colorimetric and smartphone-integrated paper device for on-site determination of arsenic (III) using sucrose modified gold nanoparticles as a nanoprobe. Microchim Acta. 2020; 187:1-9.
5. Destino J F, Cunningham K. At-Home Colorimetric and Absorbance-Based Analyses: An Opportunity for Inquiry-Based, Laboratory-Style Learning. J Chem Educ. 2020; 97 (9): 2960-6.
6. Hosu O, Lettieri M, Papara N, Ravalli A, Sandulescu R, Cristea C, et al. Colorimetric multienzymatic smart sensors for hydrogen peroxide, glucose and catechol screening analysis. Talanta. 2019; 204:525-32.
7. Choi J, Bandodkar A J, Reeder J T, Ray T R, Turnquist A, Kim S B, et al. Soft, skin-integrated multifunctional microfluidic systems for accurate colorimetric analysis of sweat biomarkers and temperature. ACS Sens. 2019; 4 (2): 379-88.
8. Xiao J, Liu Y, Su L, Zhao D, Zhao L, Zhang X. Microfluidic chip-based wearable colorimetric sensor for simple and facile detection of sweat glucose. Anal Chem. 2019; 91 (23): 14803-7.
9. Cugmas B, Struc E. Accuracy of an affordable smartphone-based teledermoscopy system for color measurements in canine skin. Sensors. 2020; 20 (21): 6234.
10. Ly B C K, Dyer E B, Feig J L, Chien A L, Del Bino S. Research techniques made simple: cutaneous colorimetry: a reliable technique for objective skin color measurement. J Invest Dermatol. 2020; 140 (1): 3-12.
11. Zhang S, Shapiro N, Gehrke G, Castner J, Liu Z, Guo B, et al. Smartphone app for residential testing of formaldehyde (SmART-form). Build Environ. 2019; 148:567-78.
12. Alfvin R L, Fairchild M D. Observer variability in metameric color matches using color reproduction media. Color Res Appl Endorsed Inter-Soc Color Counc Colour Group G B Can Soc Color Color Sci Assoc Jpn Dutch Soc Study Color Swed Colour Cent Found Colour Soc Aust Cent Fr Coul. 1997;22 (3): 174-88.
13. Sarkar A, Blonde L, Le Callet P, Autrusseau F, Stauder J, Morvan P. Modern displays: Why we see different colors, and what it means? In: 2010 2^{nd} European Workshop on Visual Information Processing (EUVIP). IEEE; 2010. p. 1-6.
14. Lia J, Hanselaera P, Smeta K A. IMPACT OF COLOR MATCHING PRIMARIES ON OBSERVER MATCHING: PART II-OBSERVER VARIABILITY.
15. Wandell B A. Foundations of vision. Sinauer Associates; 1995.
16. Johnsen S. How to measure color using spectrometers and calibrated photographs. J Exp Biol. 2016; 219 (6): 772-8.
17. Suzuki Y, Endo M, Jin J, Iwase K, Iwatsuki M. Tristimulus colorimetry using a digital still camera and its application to determination of iron and residual chlorine in water samples. Anal Sci. 2006; 22 (3): 411-4.
18. García A, Erenas M M, Marinetto E D, Abad C A, de Orbe-Paya I, Palma A J, et al. Mobile phone platform as portable chemical analyzer. Sens Actuators B Chem. 2011; 156 (1): 350-9.
19. Sumriddetchkajorn S, Chaitavon K, Intaravanne Y. Mobile-platform based colorimeter for monitoring chlorine concentration in water. Sens Actuators B Chem. 2014; 191:561-6.
20. Free Newzoo Report: Global Mobile Market Report 2021 [Internet]. Newzoo. [cited 2022 Aug. 15]. Available from: https://newzoo.com/insights/trend-reports/newzoo-global-mobile-market-report-2021-free-version
21. Nixon M, Outlaw F, Leung T S. Accurate device-independent colorimetric measurements using smartphones. PLOS One. 2020; 15 (3): e0230561.
22. Solmaz M E, Mutlu A Y, Alankus G, Kiliç V, Bayram A, Horzum N. Quantifying colorimetric tests using a smartphone app based on machine learning classifiers. Sens Actuators B Chem. 2018; 255:1967-73.
23. Abu-Mostafa Y S, Magdon-Ismail M, Lin H-T. Learning from data. Vol. 4. AMLBook New York; 2012.
24. Basri R, Jacobs D W. Lambertian reflectance and linear subspaces. IEEE Trans Pattern Anal Mach Intell. 2003; 25 (2): 218-33.
25. Garrido-Jurado S, Muñoz-Salinas R, Madrid-Cuevas F J, Marin-Jiménez MJ. Automatic generation and detection of highly reliable fiducial markers under occlusion. Pattern Recognit. 2014; 47 (6): 2280-92.
26. Garrido-Jurado S, Muñoz-Salinas R, Madrid-Cuevas F J, Medina-Carnicer R. Generation of fiducial marker dictionaries using mixed integer linear programming. Pattern Recognit. 2016; 51:481-91.
27. Tiwari S. An introduction to QR code technology. In: 2016 international conference on information technology (ICIT). IEEE; 2016. p. 39-44.
28. Bradski G. The openCV library. Dr Dobbs J Softw Tools Prof Program. 2000; 25 (11): 120-3.
29. Smith A R. Color gamut transform pairs. ACM Siggraph Comput Graph. 1978;12 (3): 12-9.
30. Weatherall I L, Coombs B D. Skin color measurements in terms of CIELAB color space values. J Invest Dermatol. 1992;99 (4): 468-73.
31. Romero-Ramirez F J, Muñoz-Salinas R, Medina-Carnicer R. Speeded up detection of squared fiducial markers. Image Vis Comput. 2018; 76:38-47.
32. Bouguet J-Y. Pyramidal implementation of the affine lucas kanade feature tracker description of the algorithm. Intel Corp. 2001; 5 (1-10): 4.
33. Crivelli T, Fradet M, Conze P-H, Robert P, Pérez P. Robust optical flow integration. IEEE Trans Image Process. 2014; 24 (1): 484-98.
34. Forsyth D A, Ponce J. Computer vision: A modern approach. 2nd. Upper Saddle River: NJ: Prentice Hall; 2011.
35. Zhang Z. A flexible new technique for camera calibration. IEEE Trans Pattern Anal Mach Intell. 2000; 22 (11): 1330-4.
36. AVCameraCalibrationData| Apple Developer Documentation [Internet]. [cited 2022 May 7]. Available from: https://developer.apple.com/documentation/avfoundation/avcameracalibrationdata
37. CameraCharacteristics [Internet]. Android Developers. [cited 2022 May 7]. Available from: https://developer.android.com/reference/android/hardware/camera2/CameraCharacteristi CS
38. Fischler M A, Bolles R C. Random sample consensus: a paradigm for model fitting with applications to image analysis and automated cartography. Commun ACM. 1981;24 (6): 381-95.
39. Sari Y A, Ginardi R H, Suciati N. Color correction using improved linear regression algorithm. In: 2015 International Conference on Information & Communication Technology and Systems (ICTS). IEEE; 2015. p. 73-8.
40. Gelfand A E, Kim H-J, Sirmans C F, Banerjee S. Spatial modeling with spatially varying coefficient processes. J Am Stat Assoc. 2003; 98 (462): 387-96.
41. Montgomery D C, Peck E A, Vining G G. Introduction to linear regression analysis. John Wiley & Sons; 2021.
42. Gonzalez R C. Digital image processing. Pearson education india; 2009.
43. Potassium Phosphate (pH 5.8 to 8.0) Preparation and Recipe| AAT Bioquest [Internet]. [cited 2022 Sep. 29]. Available from: https://www.aatbio.com/resources/buffer-preparations-and-recipes/potassium-phosphate-ph-5-8-to-8-0
44. Bartier P M, Keller C P. Multivariate interpolation to incorporate thematic surface data using inverse distance weighting (IDW). Comput Geosci. 1996; 22 (7): 795-9.
45. Shen L, Hagen J A, Papautsky I. Point-of-care colorimetric detection with a smartphone. Lab Chip. 2012; 12 (21): 4240-3.
46. Fairman H S, Brill M H, Hemmendinger H. How the CIE 1931 color-matching functions were derived from Wright-Guild data. Color Res Appl Endorsed Inter-Soc Color Counc Colour Group G B Can Soc Color Color Sci Assoc Jpn Dutch Soc Study Color Swed Colour Cent Found Colour Soc Aust Cent Fr Coul. 1997;22 (1): 11-23.
47. Pascolini D, Mariotti S P. Global estimates of visual impairment: 2010. Br J Ophthalmol. 2012 May 1;96 (5): 614.

1. A computer-implemented method of color correction for colorimetric measurements comprising:
receiving an image of a color reference board, wherein the color reference board comprises a sample region, a calibration region, and a plurality of coded markers, the sample region comprising an object of interest, and the calibration region comprising at least one color stripe;
obtaining, using the image, a plurality of respective color values associated with the at least one color stripe and the object of interest;
determining a first model based on respective coordinates associated with the coded markers;
transforming, using the first model, the respective color values and a coordinate grid associated with the object of interest into a plurality of respective adjusted color values and an adjusted coordinate grid associated with the object of interest; and
correcting, using a second model, the respective adjusted color values associated with the object of interest to obtain a plurality of respective corrected color values associated with the object of interest.

2. The computer-implemented method of claim 1, further performing, using the respective corrected color values associated with the object of interest, a colorimetric measurement.

3. The computer-implemented method of claim 1, wherein the first model is an imaging device coordinate system transformation model, and wherein the second model is a spatial varying coefficient model (SVCM).

4. (canceled)

5. The computer-implemented method of claim 1, wherein the second model is a 1^{st} or 2^{nd} order SVCM.

6. The computer-implemented method of claim 1, wherein the sample region is arranged centrally with respect to the calibration region.

7. The computer-implemented method of claim 1, wherein respective color values associated with the at least one color stripe represent a sampling of a color space.

8. The computer-implemented method of claim 7, wherein the color space is defined as a hue, saturation, and value (HSV) space.

9. The computer-implemented method of claim 1, wherein the plurality of coded markers comprise an ArUco marker.

10. The computer-implemented method of claim 9, wherein the at least one color stripe extends between a pair of the plurality of coded markers.

11. The computer-implemented method of claim 1, further comprising determining, using the coded markers, an optimal image-capture pose relative the color reference board in a three-dimensional (3D) space.

12. The computer-implemented method of claim 11, wherein the optimal image-capture pose is determined by minimizing an effect of reflectance on image capture, and wherein the optimal image-capture pose is approximately parallel to the color reference board.

13. (canceled)

14. The computer-implemented method of claim 11, further comprising providing an image capture instruction to a user in response to determining the optimal image-capture pose.

15. The computer-implemented method of claim 14, further comprising providing a coded marker tracking instruction to a user.

16. The computer-implemented method of claim 1, wherein the object of interest is a test strip.

17. A computing device comprising:
a processor; and
a memory operably coupled to the processor, wherein the memory has computer-executable instructions stored thereon that, when executed by the processor, cause the processor to:
receive an image of a color reference board, wherein the color reference board comprises a sample region, a calibration region, and a plurality of coded markers, the sample region comprising an object of interest, and the calibration region comprising at least one color stripe;
obtain, using the image, a plurality of respective color values associated with the at least one color stripe and the object of interest;
determine a first model based on respective coordinates associated with the coded markers;
transform, using the first model, the respective color values and a coordinate grid associated with the object of interest into a plurality of respective adjusted color values and an adjusted coordinate grid associated with the object of interest; and
correct, using a second model, the respective adjusted color values associated with the object of interest to obtain a plurality of respective corrected color values associated with the object of interest.

18. (canceled)

19. (canceled)

20. (canceled)

21. (canceled)

22. (canceled)

23. (canceled)

24. (canceled)

25. (canceled)

26. (canceled)

27. (canceled)

28. The computing device of claim 17, wherein the computer-executable instructions further comprise instructions that, when executed by the processor, cause the processor to further:
determine, using the coded markers, an optimal image-capture pose relative the color reference board in a three-dimensional (3D) space.

29. The computing device of claim 28, wherein the optimal image-capture pose is determined by minimizing an effect of reflectance on image capture, and wherein the optimal image-capture pose is approximately parallel to the color reference board.

30. (canceled)

31. The computing device of claim 28,
wherein the computer-executable instructions further comprise instructions that, when executed by the processor, cause the processor to further:
provide an image capture instruction to a user in response to determining the optimal image-capture pose.

32. The computing device of claim 28,
wherein the computer-executable instructions further comprise instructions that, when executed by the processor, cause the processor to further:
provide a coded marker tracking instruction to a user.

33. (canceled)

34. A system comprising:
a color reference board, wherein the color reference board comprises a sample region, a calibration region, and a plurality of coded markers, the sample region being configured to receive an object of interest, and the calibration region comprising at least one color stripe; and
a portable computing device comprising a processor, a memory operably coupled to the processor, and an imaging device, wherein the memory has computer-executable instructions stored thereon that, when executed by the processor, cause the processor to:
receive an image of the color reference board captured by the imaging device;
obtain, using the image, a plurality of respective color values associated with the at least one color stripe and the object of interest;
determine a first model based on respective coordinates associated with the coded markers;
transform, using the first model, the respective color values and a coordinate grid associated with the object of interest into a plurality of respective adjusted color values and an adjusted coordinate grid associated with the object of interest; and
correct, using a second model, the respective adjusted color values associated with the object of interest to obtain a plurality of respective corrected color values associated with the object of interest.
